(19) United States
(12) Patent Application Publication
(10) Pub. No.: US 2025/0310826 A1
(43) Pub. Date: Oct. 2, 2025

(54) TECHNOLOGIES FOR CONGESTION CONTROL IN WIRELESS NETWORKS

(71) Applicant: Apple Inc., Cupertino, CA (US)

(72) Inventor: Shahram Talakoub, San Jose, CA (US)

(73) Assignee: Apple Inc., Cupertino, CA (US)

(21) Appl. No.: 19/006,619

(22) Filed: Dec. 31, 2024

Related U.S. Application Data
(60) Provisional application No. 63/572,878, filed on Apr. 1, 2024.

(51) Int. Cl. H04W 28/02; H04W 24/08

(52) U.S. Cl. CPC H04W 28/0289; H04W 24/08; H04W 28/0231

(57) ABSTRACT

The present application relates to devices and components including apparatus, systems, and methods for managing traffic based on network congestion.

### CROSS-REFERENCE TO RELATED APPLICATION

This application claims the benefit of U.S. Provisional Patent Application No. 63/572,878, filed Apr. 1, 2024, which is herein incorporated by reference in its entirety for all purposes.

### FIELD

This application relates to the field of wireless networks and, in particular, to technologies for congestion control in wireless networks.

### BACKGROUND

Congestion control in wireless networks is provided as a mechanism to efficiently distribute network resources in a highly-loaded scenarios. Continued developments in the area of congestion control is desired.

### BRIEF DESCRIPTION OF THE DRAWINGS

FIG. 1 illustrates a network environment in accordance with some embodiments.

FIG. 2 illustrates a user equipment in accordance with some embodiments.

FIG. 3 illustrates queues in accordance with some embodiments.

FIG. 4 is a table of transmit backoff values in accordance with some embodiments.

FIG. 5 illustrates a sigmoid-like cost function in accordance with some embodiments.

FIG. 6 illustrates a rectified-linear-like cost function in accordance with some embodiments.

FIG. 7 illustrates an operational flow/algorithmic structure in accordance with some embodiments.

FIG. 8 illustrates geometric and Poisson distributions in accordance with some embodiments.

FIG. 9 illustrates another operational flow/algorithmic structure in accordance with some embodiments.

FIG. 10 illustrates another operational flow/algorithmic structure in accordance with some embodiments.

FIG. 11 illustrates another operational flow/algorithmic structure in accordance with some embodiments.

FIG. 12 illustrates a user equipment in accordance with some embodiments.

FIG. 13 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A)B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

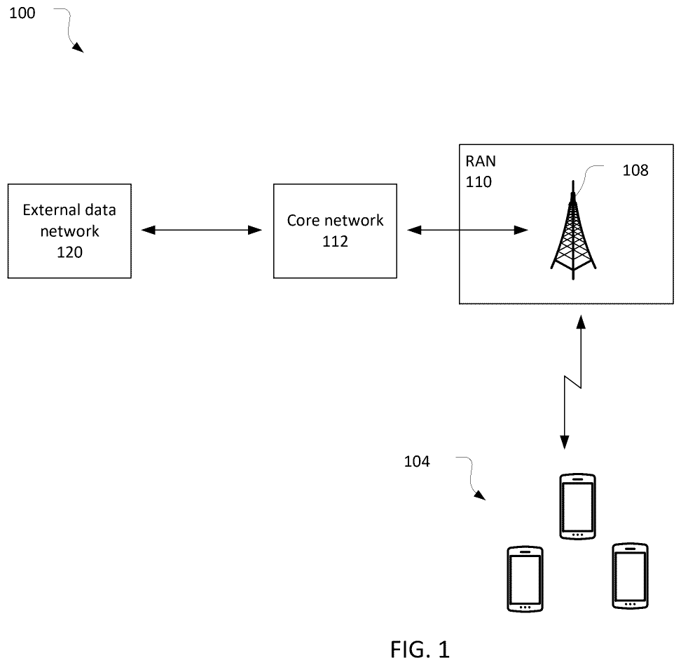

FIG. 1 illustrates a network environment 100 in accordance with some embodiments. The network environment 100 may include a number of user equipments (UEs) 104 communicatively coupled with a base station 108 of a radio access network (RAN) 110. The UEs 104 and the base station 108 may communicate over air interfaces compatible with Third Generation Partnership Project (3GPP) Technical Standards (TSs) such as those that define a Fifth Generation (5G) new radio (NR) system or a later system. The base station 108 may provide user plane and control plane protocol terminations toward the UE 104.

The network environment 100 may further include a core network 112 and an external data network 120. For example, the core network 112 may comprise a 5th Generation Core network (5GC) or later generation core network. The core network 112 may be coupled to the base station 108 via a fiber optic or wireless backhaul. The core network 112 may provide functions for the UEs 104 via the base station 108. These functions may include managing subscriber profile information, subscriber location, authentication of services, or switching functions for voice and data sessions.

Congestion control in the network environment 100 may be bidirectional. Congestion control for downlink traffic, for example, from the core network 112 to the UEs 104, may be referred to as forward congestion control. Congestion control for uplink traffic, for example, from the UEs 104 to the core network 112, may be referred to as reverse congestion control.

Reverse congestion control may be enabled by the network (e.g., components of RAN 110 or core network 112) transmitting broadcast interval (BI) information to the UEs 104. The BI information may be periodically transmitted, for example, every 2.56 seconds, and may include two congestion level indictors, one to indicate a transmit (Tx) backoff level and one to indicate a user experience (Ux) congestion level.

The network may have a congestion algorithm that outputs the Tx backoff level indicator based on a quantitative measurement of a network state and can change from cycle-to-cycle. The Tx backoff level indicator may indicate a Tx backoff level that may be used by the UEs 104 to define a per-cycle random draw function.

The Tx backoff level indicator may include four bits that define up to 16 Tx backoff levels. In general, a Tx backoff level may be associated with a backoff percentage value. For performing uplink transmissions, a UE may determine whether transmission is allowed using a function that provides the set backoff percentage value. For example, if the backoff percentage value is 75%, a UE may use a function that permits transmission, on average, once for every four attempts.

The network may also have a Ux filtering and hysteresis function that filters the output of the congestion algorithm to provide a qualitative assessment of the network state that changes relatively slowly to the Tx backoff level. The Ux congestion level indicator may be two bits that define up to four Ux congestion backoff levels (e.g., no Ux congestion, Ux light congestion, Ux moderate congestion, or Ux severe congestion). A UE may provide a user with information related to the Ux congestion level and may disable certain traffic based on the level as will be described in more detail herein.

In existing networks, all message types are backed off equally. There is no concept of priority with respect to congestion backoff. Such legacy congestion control may make the network susceptible to cellular network outage or disaster. Further, such legacy congestion control may be associated with flip-flop behavior for some traffic types. For example, the traffic may be enabled for a short time and disabled for longer periods of time, with this network behavior continuously repeating. This may result in a very poor user experience. Still further, providing high-priority traffic and lower-priority traffic with the same backoff values may result in the high-priority traffic having excessive backoff values due to the presence of a high-volume of the lower-priority traffic.

Embodiments of the present disclosure provide granulated congestion backoff control in which, for a given backoff congestion level, traffic associated with different applications, application types, or priority levels may use different backoff values. This may improve a user experience and better utilize network capacity. Additional aspects provide for usage-based fairness considerations in congestion control and improved backoff strategies that avoids occurrences of long transmission delays.

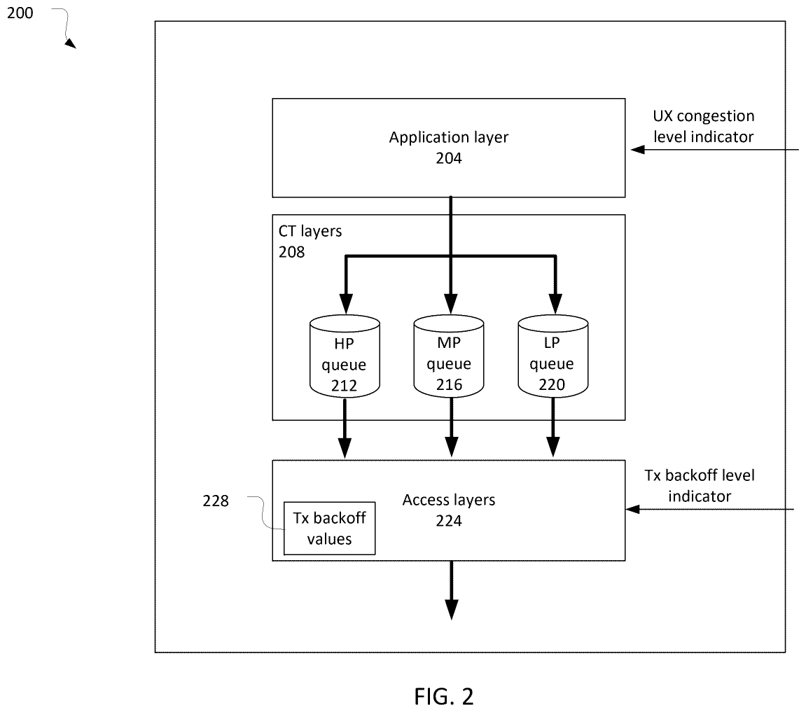

FIG. 2 illustrates a UE 200 in accordance with some embodiments. The UE 200 may be similar to, and interchangeable with, any of the UEs 104. The UE 200 may include an application layer 204 that generates or consumes application traffic. In the uplink, the application layer 204 provides traffic from one or more applications to a core-telephony (CT) layer 208. The CT layer 208 may distribute the uplink traffic into a number of queues, with each queue being associated with a different priority level in order to provide differentiated quality of service (QOS). The CT layer 208 may map the traffic to a specific queue based on the priority level associated with the application traffic. Each priority level may be associated with one or more types of application traffic. As shown, the CT layer may have a high-priority (HP) queue 212, a medium-priority (MP) queue 216, and a low-priority (LP) queue 220. In other embodiments, the CT layer 208 may include other numbers of queues.

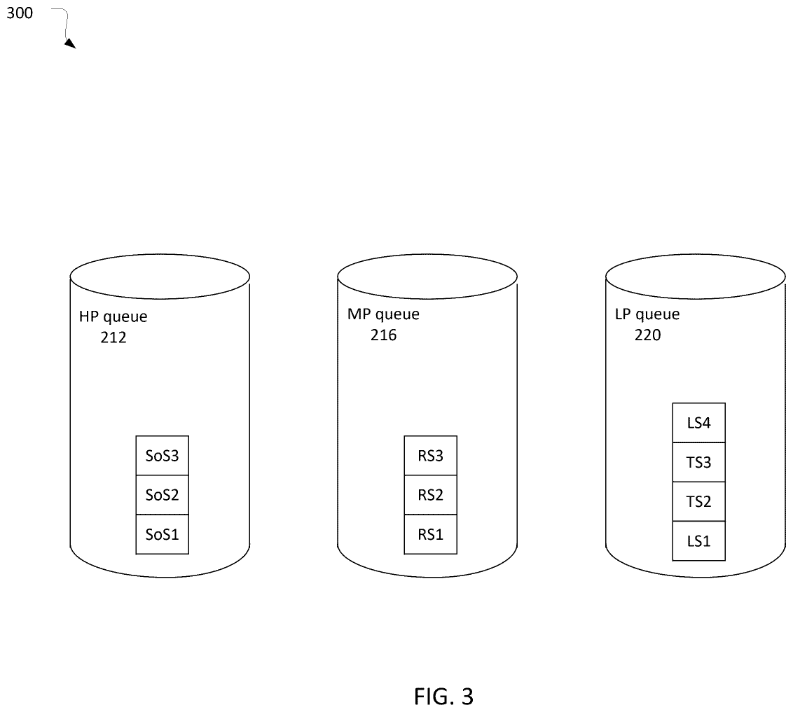

FIG. 3 illustrates the queues associated with the CT layer 208 in accordance with some embodiments. As shown, traffic from a location services (LS) application and a text services (TS) application may be mapped to the LP queue 220; traffic from a roadside assistance services (RS) application may be mapped to the MP queue 216; and traffic from an emergency services (SoS) application may be mapped to the HP queue 212. This mapping of application traffic to queues is not restrictive.

The CT layer 208 may prioritize queues based on their priority values for a given transmission opportunity. A message in a specific priority queue may be provided to an access layer 224 of the UE 200 for transmission if the higher-priority queues are empty and the message is the earliest one its own priority queue (for example, the individual queues may be first-in-first-out (FIFO) queues). The access layer 224 may be implemented by baseband circuitry of the UE 200.

The access layers 224 may place the messages received from the CT layer 208 in its transmit buffer for transmission.

The application layer 204 may receive the Ux congestion level indicator from the network and provide the user with information related to the indicated Ux congestion level. Further, if certain traffic is disabled based on the Ux congestion level, the application layer 204 may stop issuing traffic from disabled traffic to the CT layer 208.

The access layers 224 may receive the Tx backoff level indicator from the network. The access layers 224 may access stored Tx backoff values 228 based on indicated Tx backoff level and information about the buffered messages (for example, associated application, application type, or priority level). The access layers 224 may then transmit the buffered messages by performing a backoff analysis with the indicated Tx backoff level.

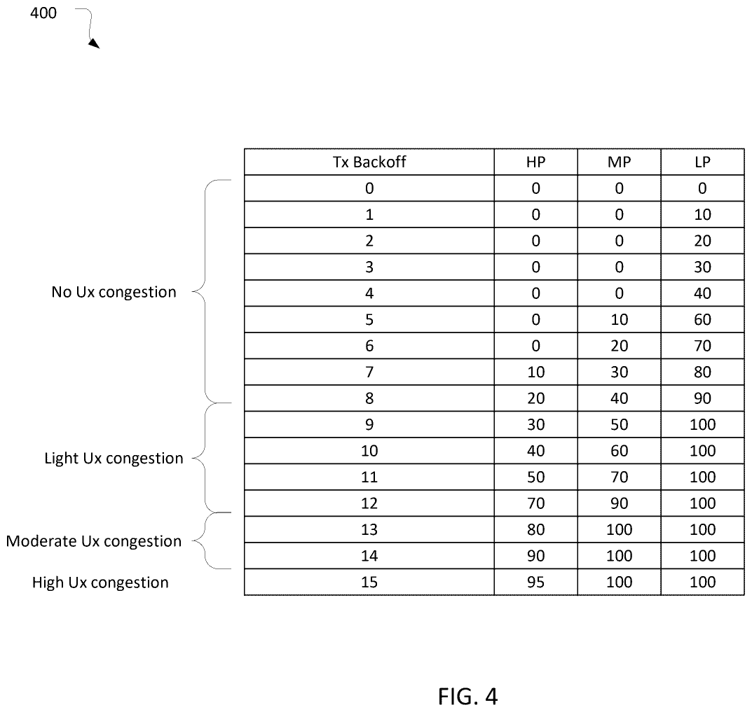

FIG. 4 is a table 400 of Tx backoff values for different application traffic in accordance with some embodiments. Table 400 provides 16 Tx backoff levels that may be communicated through a four-bit Tx backoff level indicator. As shown in table 400, each priority level may be associated with a distinct set of backoff values that correspond to the Tx backoff levels. In this example, there may be a first set of backoff levels corresponding to high-priority traffic (for example, SoS traffic), a second set of backoff levels corresponding to medium-priority traffic (e.g., RS traffic), and a third set of set of backoff levels corresponding to low-priority traffic (e.g., LS and TS traffic).

For the first Tx backoff level (e.g., Tx backoff level=0), none of the traffic will need to be backed off (e.g., Tx backoff values=0 for all priority levels). For the second Tx backoff level (e.g., Tx backoff level=1), none of the traffic will need to be backed off for the high/medium priority levels, but the low-priority level will be backed off 10% of the time (e.g., Tx backoff values=0 for high/medium priority levels, and Tx backoff value=10 for the low-priority level). Other congestion levels may be interpreted in a similar manner based on Table 400.

Tx backoff levels 0-8 may be associated with a lowest Ux congestion level, e.g., no Ux congestion. In the lowest Ux congestion level, traffic of all priorities may be transmitted, with varying degrees of backoff. Tx backoff levels 9-12 may be associated with a light Ux congestion level. In the light Ux congestion level, transmission of low-priority traffic may be disabled, for example, the traffic will be backed off 100% of the time. Tx backoff levels 13 and 14 may be associated with a moderate Ux congestion level. In the moderate Ux congestion level, transmission of low-/medium-priority traffic may be disabled, and the high-priority traffic will be backed off 80% or 90% of the time. Tx backoff level 15 may be associated with a high Ux congestion level. In the high Ux congestion level, transmission of low-/medium-priority traffic may be disabled, and the high-priority traffic will be backed off 95% of the time.

While table 400 provides distinct sets of backoff values for different priority levels, other embodiments may provide distinct sets of backoff values for different applications or application types in a similar manner. Furthermore, the specific values provided in table 400 are merely examples and do not restrict embodiments using other values.

When a message is in the transmit buffer of the access layers 224 and a higher-priority message awaits transmission, the handling of the higher-priority message may require special attention. For example, if an SoS message is queued for transmission, the UE 200 may prioritize it above all other message types. The CT layers 208 may forward the SoS message to the access layers 224 for immediate handling. The access layers 224 may drop any lower priority messages and inform the CT layers 208 of transmission failure for the dropped messages.

For messages of other types, the access layers 224 will attempt to transmit its buffered messages before processing new ones (excluding SoS), unless: the CT layers 208 signal the availability of a higher-priority message (excluding SoS), and the existing message in the buffer of the access layers 224 is subject to 100% backoff, and the corresponding Ux bits indicate traffic blocking for that traffic priority class.

In some instances, some UEs may use reverse bandwidth unevenly, which may impact fair access for all users by causing congestion. System congestion worsens overall user experience by eroding forward link margin and increasing latency. Some embodiments describe a UE considering their recent transmission history in the backoff analysis. For example, a UE may adjust their backoff value based on a number of times they have transmitted over-the-air for a specific priority class (or application or application type) within a predetermined period of time before a time of the backoff analysis. The predetermined period of time may be defined as, for example, the last T cycles. In some embodiments, this backoff adjustment may only be performed when there is a predetermined threshold level of reverse congestion.

For example, if a base backoff value (rev_backoff) is greater than a predetermined threshold (e.g., 0), an extra backoff (or “delta value”) may be added, else no extra backoff may be added. In some embodiments, the extra backoff (extra_backoff) may be based on a Sigmoid, or sigmoid-like, cost function based on a maximum number of attempts within T (Tx_{max,T}) and a parameter k (e.g., extra_backoff=Sigmoid (Tx_{max,T}, k). The maximum number of attempts within T may be considered a first boundary number of transmissions that, if reached, is to be associated with a total backoff value of 100.

In other embodiments, the extra backoff may be based on a rectified linear, or rectified-linear-like, cost function based on a maximum number of attempts within T and a number of transmissions within T that may be made without penalty (Tx_{nopenalty,T}) (e.g., extra_backoff=Rectified_linear(Tx_{max,T}, Tx_{nopenalty,T}). The number of transmissions within T made without penalty may be considered a second boundary number of transmissions that is to be associated with a delta value of 0.

The total backoff value may be set equal to min(rev_backoff+extra_backoff, 1).

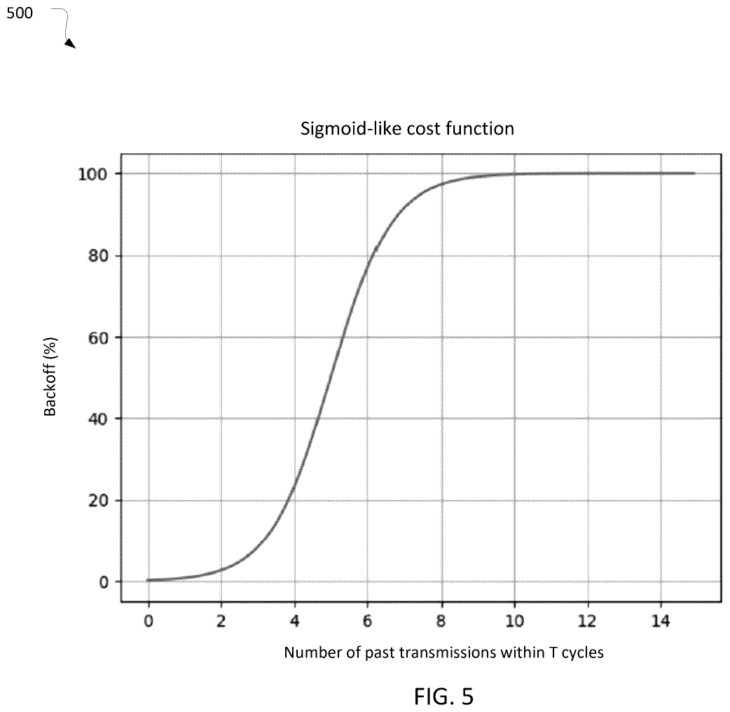

FIG. 5 illustrates a sigmoid-like cost function 500 in accordance with some embodiments. The sigmoid-like cost function 500 may include parameters (k=1.2, and mean=5) and defined by:

$$Sigmoid {=}^{Δ} 1. - \frac{1}{( 1.0 + exp ( k x ( {Tx}_{T} - mean ) ) )} ,$$

where Tx_{T} is a number of transmissions within T.

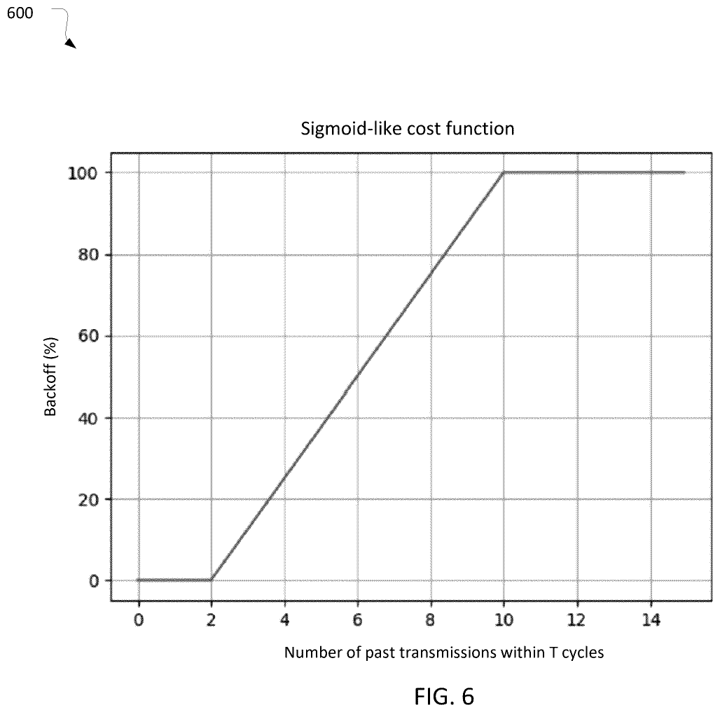

FIG. 6 illustrates a rectified-linear-like cost function 600 in accordance with some embodiments. The rectified-linear-like cost function 600 may include parameters (TX_{nopenalty;T}=2, Tx_{max,T}=10) and defined by:

$$Rectified Linear {=}^{Δ} \{ \begin{matrix}0 , & if 0 \leq x < {Tx}_{nopenalty , T} \\ \frac{( x - {Tx}_{nopenalty , T} )}{( {Tx}_{max , T} - {Tx}_{nopenalty , T} )} , & if {Tx}_{nopenalty , T} \leq x < {Tx}_{max , T} \\ 1 & if x \geq {Tx}_{max , T}\end{matrix} .$$

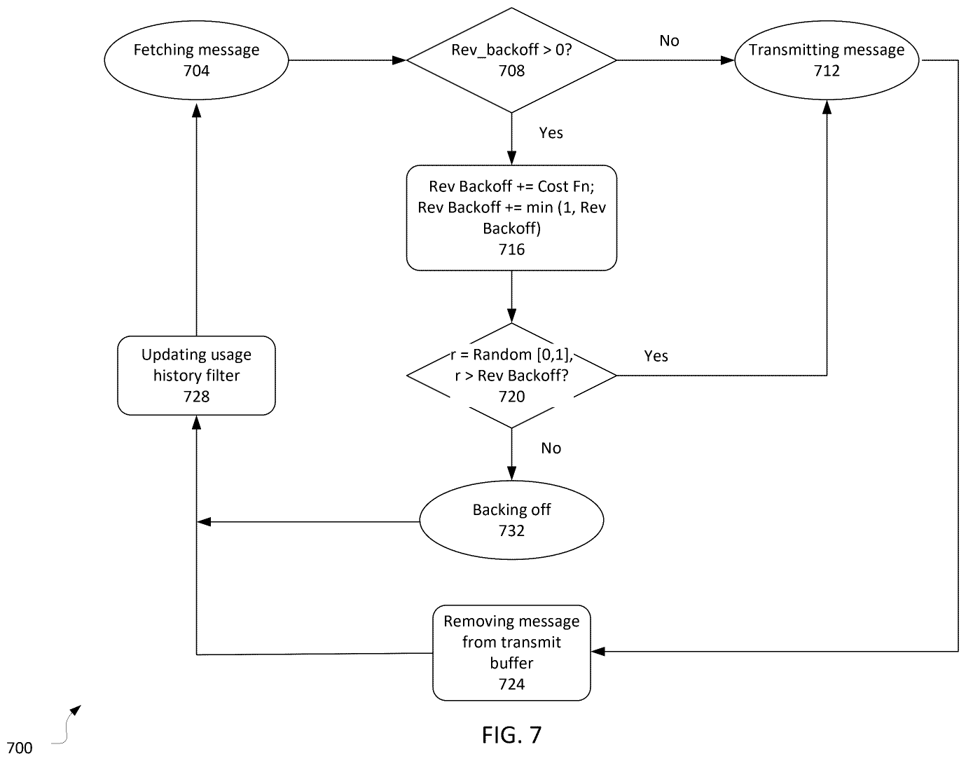

FIG. 7 illustrates an operational flow/algorithmic structure 700 in accordance with some embodiments. The operation flow/algorithmic structure 700 may be performed or implemented by a UE such as, for example, a UE of UEs 104 or UE 200; or components thereof, for example, baseband processor 1204A.

The operational flow/algorithmic structure 700 may include, at 704, fetching a message for transmission. In some embodiments, the message may be the next message in a transmit buffer of a baseband processor.

The operational flow/algorithmic structure 700 may further include, at 708, determining whether a backoff value is greater than zero. The backoff value may be the base value. If the backoff value is not greater than zero, the operational flow/algorithmic structure 700 may advance to transmitting the message at 712.

If, at 708, it is determined that the backoff value is greater than zero (e.g., there is congestion present), the operational flow/algorithmic structure 700 may include, at 716, generating a total backoff value by adding a cost function to the base backoff value (e.g., rev_backoff+=cost function; rev_backoff=min (1.0, rev_backoff)).

The operational flow/algorithmic structure 700 may further include, at 720, determining whether a transmission is permitted based on the updated, total backoff value. This may be done by selecting a random number, r, between 0 and 1 and, if the random number is greater that the total backoff value (e.g., r=Random [0.0, 1.0]; r>rev_backoff), the transmission is permitted and the operational flow/algorithmic structure 700 advances to transmitting the message at 712.

After transmitting the message at 712, the operational flow/algorithmic structure 700 may advance to removing the message from the transmit buffer at 724. The operational flow/algorithmic structure 700 may then advance to updating usage history filter at 728. This may include updating the number of transmitted messages and shifting the time window.

If it is determined, at 720, that the transmission is not permitted (e.g., r≤rev_backoff), the operational flow/algorithmic structure 700 advances to backing off at 732 and advancing to updating the usage history filter at 728. In this instance, the number of transmitted messages will not be increased as the message was not transmitted, but the time window will be shifted. The operational flow/algorithmic structure 700 may then advance to fetching another message at 704. If a relatively higher-priority message is available, it will be fetched at 704 and a state of the relatively lower-priority message may be saved for an attempt at retransmission at a later time. If a higher-priority message is not available, the operational flow/algorithmic structure 700 may advance to directly attempting a retransmission.

In some embodiments, determination of the cost function may be based on parameters that are specific to a priority level, application, or application type. For example, different priority levels/applications/application types may be associated with different cost functions, parameters, or congestion thresholds for determining whether to apply the cost function (e.g., the value used at 708).

In some instances, utilizing the random number and backoff value to determine whether a transmission is permitted at 720 of the operational flow/algorithmic structure 700 may provide a geometric distribution with a pronounced long tail. In high-congestion scenarios, this effect may become particularly prominent and may even extend by an order of magnitude beyond the mean. This may result in long latencies or inconsistent user experience during network congestion.

To address this scenario, some embodiments describe using distributions with bounded, or rapidly decaying tails. For example, the UE 200 may incorporate alternative distributions such as Gaussian or Poisson distributions.

For example, in some embodiments, for each unicast message, the access layers 224 may select a number from a Poisson distribution to determine a future transmission cycle. Regardless of future congestion values, the access layers 224 will output the unicast message for transmission at the specified cycle. This may be done by identifying a Poisson distribution that has a mean value that equals a mean value of the geometric distribution that is associated with the backoff value. A random number may be used to select a value from that Poisson distribution. The value may correspond to a future transmission cycle that is to be used for the transmission of the subject traffic.

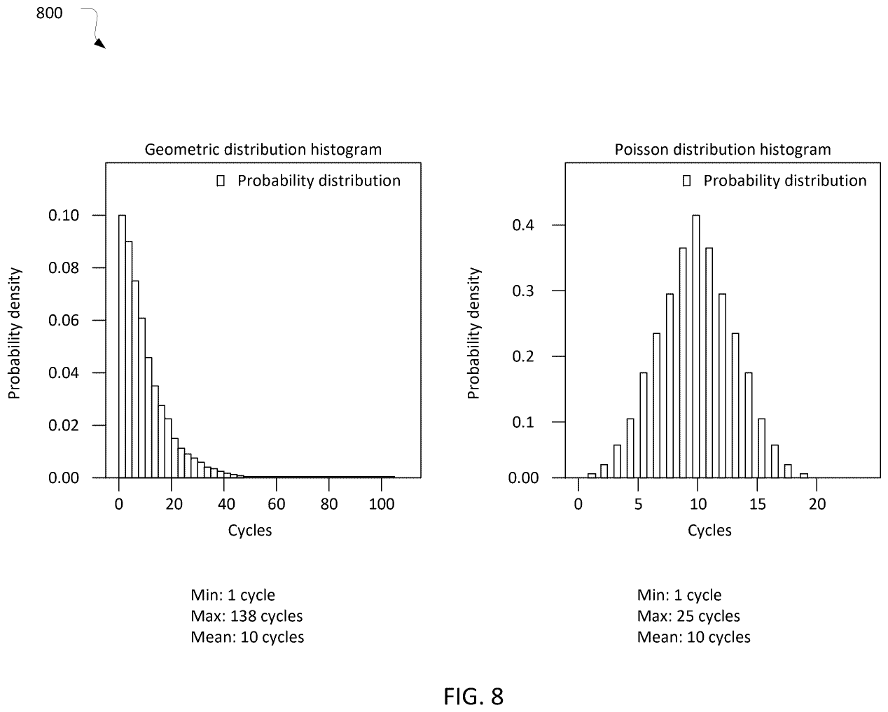

FIG. 8 illustrates a geometric distribution 804 and a Poisson distribution 808 in accordance with some embodiments. Consider, for example, that the total backoff value is set at 90%. This may provide the geometric distribution 804 with a mean number of transmissions for success at 10 cycles. In this instance, the access layers 224 may generate a random number and apply it to the Poisson distribution 808 with the same mean as the geometric distribution 804, for example, mean=10. The transmission cycle will then be calculated as the current cycle plus the result of the random draw from the Poisson distribution 808.

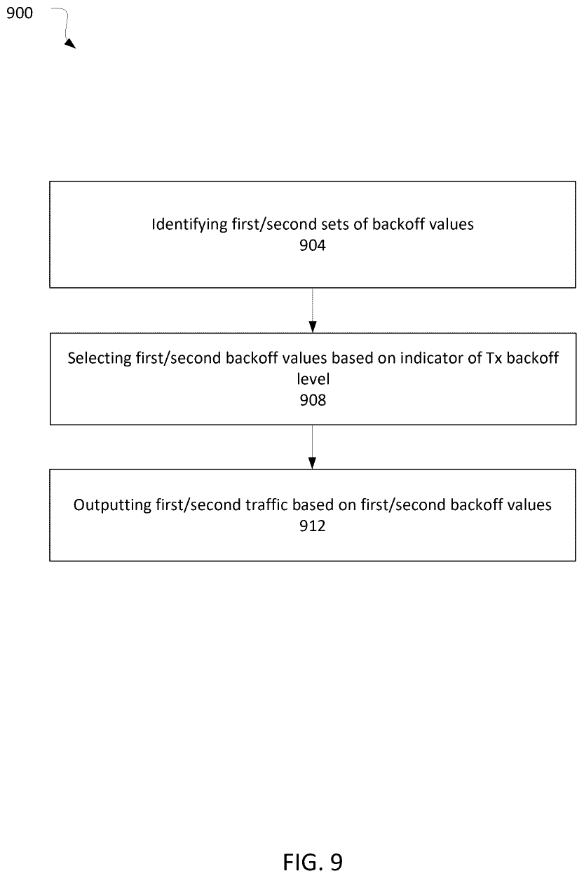

FIG. 9 illustrates an operational flow/algorithmic structure 900 in accordance with some embodiments. The operation flow/algorithmic structure 900 may be performed or implemented by a UE such as, for example, one of UEs 104 or UE 200; or components thereof, for example, baseband processor 1204A.

The operation flow/algorithmic structure 900 may include, at 904, identifying first/second sets of backoff values. The first set of backoff values may be associated with a first priority level, application, or application type, and the second set of backoff values may be associated with a second priority level, application, or application type. The first set may include at least some backoff values that are different from the second set.

The operation flow/algorithmic structure 900 may further include, at 908, selecting first/second backoff values based on indicator of Tx backoff level. The indicator may be received from a network and may indicate the Tx backoff level that is to be used for a broadcast interval. The first and second backoff values may be different from one another.

The operation flow/algorithmic structure 900 may further include, at 912, outputting first/second traffic based on the first/second backoff values.

In some embodiments, a backoff value may correspond to a backoff percentage and a determination of whether a transmission is allowed in a given transmission cycle may be determined using a geometric distribution with the backoff percentage. For example, if the backoff value is 75%, a message may be transmitted in a given transmission cycle 25% of the time and backed-off 75% of the time. In some embodiments, the geometric distribution with the backoff percentage may be done based on selecting a random number. For example, if a random number, selected between 0.0 and 1, is greater than 0.75, the message may be transmitted. Else, the message may be backed off.

In some embodiments, the Tx backoff level determined based on the indicator at 908 may be a base value. The operation flow/algorithmic structure 900 may then further include determining a delta value based on a number of past transmissions within a predetermined time window. The delta value may be added to the base value to determine an adjusted, total backoff value that may be used to determine whether messages are to be output for transmission.

In some embodiments, the delta value may be determined with a cost function (e.g., a sigmoid-like cost function or a rectified-linear-like cost function). The cost function may have parameters that include a first boundary number of transmissions associated with a delta value of 0% (e.g., Tx_{permitted,T}) and a second boundary number of transmissions associated with a delta value of 100% (e.g., Tx_{max,T}). The delta value percentages may be with respect to a remaining possibility of transmission in light of the base value. For example, a 0% delta value may not add any additional delay to the base value and a 100% delta value may, when added to the base value, result in a total backoff value of 100%.

In some embodiments, the cost functions or parameters thereof may be selected based on a priority level, application, or application type associated with the traffic.

In some embodiments, the operation flow/algorithmic structure 900 may additionally include identifying an indicator of a Ux congestion level and providing, to a user, an indication of the Ux congestion level. The indicator of the Ux congestion level may be received from a network. In some embodiments, the receipt of the Ux congestion level and provision of the resulting indication may be performed by an application layer of a UE.

In some embodiments, the traffic may be output by determining a mean value based on the backoff value. For example, the mean value may correspond to mean number of transmission cycles in which transmissions would occur using a geometric distribution with the backoff value. A number may then be randomly selected within a range defined by another distribution (e.g., a Poisson distribution) that has the same mean value. The selected number may be used to determine a future transmission cycle in which a particular message is to be output for transmission.

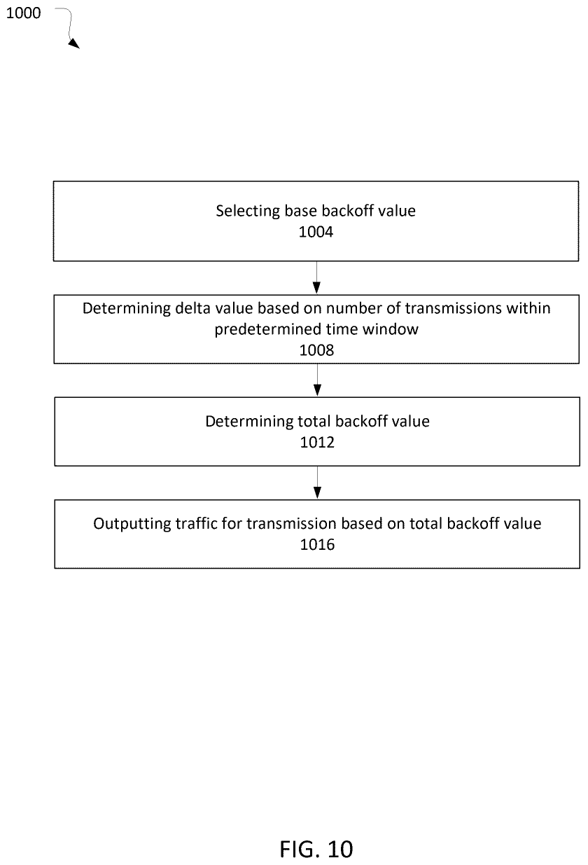

FIG. 10 illustrates an operational flow/algorithmic structure 1000 in accordance with some embodiments. The operation flow/algorithmic structure 1000 may be performed or implemented by a UE such as, for example, one of UEs 104 or UE 200; or components thereof, for example, baseband processor 1204A.

The operation flow/algorithmic structure 1000 may include, at 1004, selecting a base backoff value from a set of backoff values. The selection may be based on an indicator of a Tx backoff level provided by the network for a broadcast interval.

The operation flow/algorithmic structure 1000 may further include, at 1008, determining a delta value based on a number of transmissions within a predetermined time window.

In some embodiments, the delta value may be determined with a cost function having parameters similar to that described elsewhere herein.

The operation flow/algorithmic structure 1000 may further include, at 1012, determining a total backoff value based on the base backoff value and the delta value.

In some embodiments, the delta value may only be determined and added to the base value if the base backoff value is greater than a predetermined threshold. The predetermined threshold may be based on a priority level, application, or application type associated with the traffic.

While some embodiments describe the delta value being a positive value that increases the backoff percentage, in other embodiments, the delta value may be a negative value that decreases the backoff percentage. This may permit UEs that have a number of past transmissions in the transmission window less than a threshold to have a backoff value that is lower than the base value.

The operation flow/algorithmic structure 1000 may further include, at 1016, outputting, for transmission, traffic based on the total backoff value.

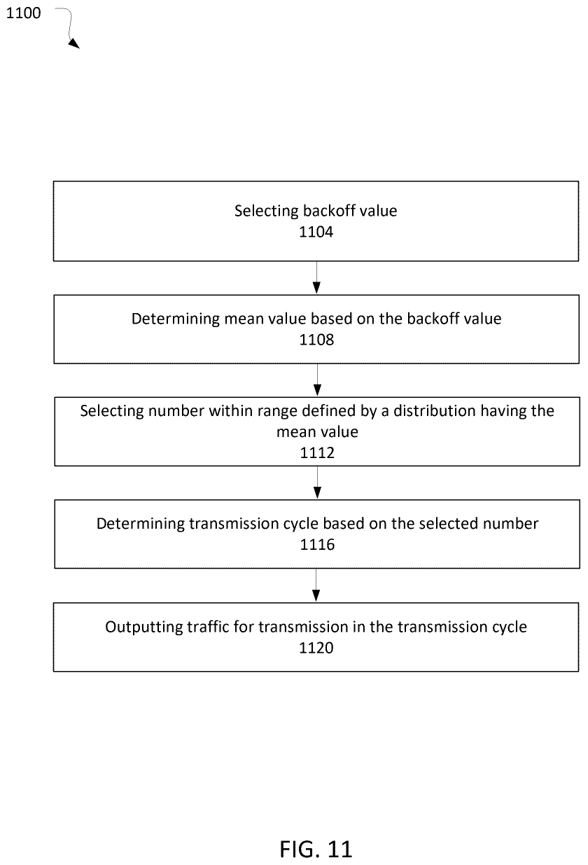

FIG. 11 illustrates an operational flow/algorithmic structure 900 in accordance with some embodiments. The operation flow/algorithmic structure 900 may be performed or implemented by a UE such as, for example, one of UEs 104 or UE 200; or components thereof, for example, baseband processor 1204A.

The operation flow/algorithmic structure 1100 may include, at 1104, selecting a backoff value based on an indicator of a Tx backoff level. The indicator of the Tx backoff level may provided by the network for a broadcast interval.

The operation flow/algorithmic structure 1100 may further include, at 1108, determining a mean value based on the backoff value. For example, the mean value may be the mean value of a geometric distribution with the backoff value.

The operation flow/algorithmic structure 1100 may further include, at 1112, selecting a number within a range defined by another distribution having the mean value. For example, the other distribution may be a Poisson distribution.

In some embodiments, the Poisson distribution may be used if the mean value is greater than a predetermined threshold. This may prevent the range from having values less than 0. If the mean value is not greater than the predetermined threshold, the geometric distribution may be used as described elsewhere herein.

The operation flow/algorithmic structure 1100 may further include, at 1116, determining a transmission cycle based on the number. For example, if the selected number is N, the transmission cycle may be the N^{th} transmission cycle from a current transmission cycle.

The operation flow/algorithmic structure 1100 may further include, at 1120, outputting traffic for transmission in the transmission cycle determined at 1116.

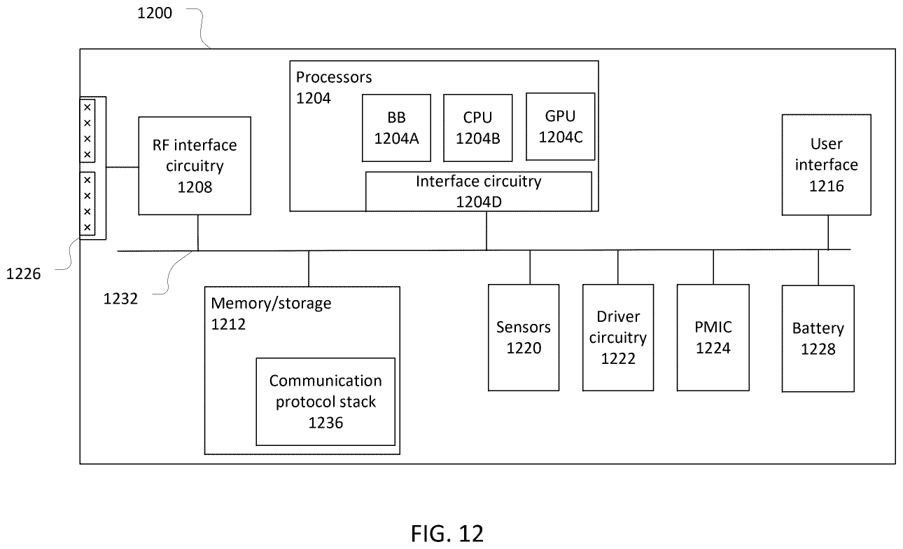

FIG. 12 illustrates a UE 1200 in accordance with some embodiments. The UE 1200 may be similar to and substantially interchangeable with a UE of UEs 104 or UE 200.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor (BB) 1204A, central processor unit (CPU) 1204B, and graphics processor unit (GPU) 1204C. The processors 1204 may include any type of circuitry or processor circuitry that executes or otherwise operates computer-executable instructions, such as program code, software modules, or functional processes from memory/storage 1212 to cause the UE 1200 to perform congestion-based operations as described herein. The processors 1204 may also include interface circuitry 1204D to communicatively couple the processor circuitry with one or more other components of the UE 1200.

In some embodiments, the baseband processor 1204A may access a communication protocol stack 1236 in the memory/storage 1212 to communicate over a 3GPP compatible network. In general, the baseband processor 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 may store NP information upon which the NP switching procedures described herein are based.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power-saving mechanisms of the UE 1200 including DRX as discussed herein.

A battery 1228 may power the UE 1200, although in some examples the UE 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

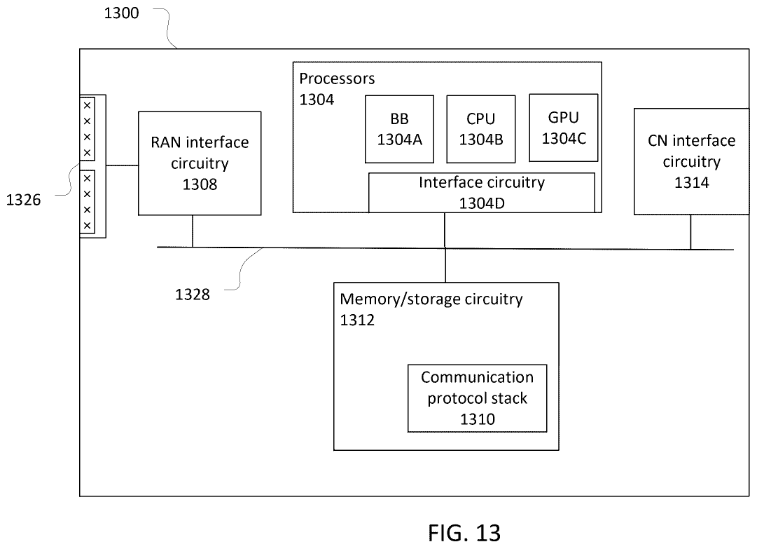

FIG. 13 illustrates a network device 1300 in accordance with some embodiments. The network device 1300 may be similar to and substantially interchangeable with a node of the RAN 110 or core network 112.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the network device 1300 to perform congestion-related operations as described herein. The processors 1304 may also include interface circuitry 1304D to communicatively couple the processor circuitry with one or more other components of the network device 1300.

The CN interface circuitry 1314 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

In some embodiments, the network device 1300 may be a base station and may be coupled with satellites using the antenna structure 1326. In other embodiments, the network device 1300 may be a satellite and may be coupled with the base station using the antenna structure 1326.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: identifying a first set of backoff values; identifying a second set of backoff values; selecting, based on an indicator of a transmit (Tx) backoff level, a first backoff value from the first set of backoff values and a second backoff value from the second set of backoff values, wherein the first backoff value is different from the second backoff value; and outputting, for transmission, first traffic based on the first backoff value; and outputting, for transmission, second traffic based on the second backoff value.

Example 2 includes the method of example 1 or some other example herein, wherein the first set of backoff values is associated with a first priority level and the second set of backoff values is associated with a second priority level.

Example 3 includes the method of example 2 or some other example herein, further comprising: determining a number of transmissions within a predetermined time window; determining a delta value based on the number of transmissions; determining a total backoff value based on the first backoff value and the delta value; and outputting, for transmission, the first traffic based on the total backoff value.

Example 4 includes the method of example 3 or some other example herein, wherein determining the delta value comprises: determining the delta value with a cost function having parameters that include a first boundary number of transmissions associated with a delta value of 0% and a second boundary number of transmissions associated with a delta value of 100%.

Example 5 includes the method of example 4 some other example herein, wherein the cost function is a sigmoid-like cost function or a rectified-linear-like cost function.

Example 6 includes the method of example 4 some other example herein, wherein the total backoff value is a first total backoff value, the delta value is a first delta value, the cost function is a first cost function associated with the first priority level and the method further comprises: determining a second delta value with a second cost function associated with the second priority level, wherein the second cost function has a third boundary number of transmissions associated with a delta value of 0% and a fourth boundary number of transmissions associated with a delta value of 100%, wherein the first boundary number is different from the third boundary number or the second boundary number is different from the fourth boundary number; determining a second total backoff value based on the second backoff value and the second delta value; and outputting the second traffic based on the second total backoff value.

Example 7 includes the method of example 1 or some other example herein, wherein the first set of backoff values is associated with a first application and the second set of backoff values is associated with a second application.

Example 8 includes the method of example 1 or some other example herein, further comprising: identifying an indicator of a user experience (Ux) congestion level; and providing, to a user, an indication of the Ux congestion level.

Example 9 includes the method of example 1 or some other example herein, wherein the first backoff value and the second backoff value correspond to a first backoff percentage and a second backoff percentage, respectively.

Example 10 includes the method of example 1 or some other example herein, wherein outputting the first traffic comprises: determining, using a geometric distribution with the first value, transmission of the first traffic is allowed; and outputting the first traffic based on said determining that the transmission of the first traffic is allowed.

Example 11 includes the method of example 1 or some other example herein, wherein outputting the first traffic comprises: determining a mean value based on the first backoff value; selecting a number within a range defined by a distribution having the mean value; determining a transmission cycle based on the number; and outputting the first traffic for transmission in the transmission cycle.

Example 12 includes the method of example 11 or some other example herein, wherein the distribution is a Poisson distribution.

Example 13 includes a method comprising: selecting, based on an indicator of a transmit (Tx) backoff level, a base backoff value from a set of backoff values; determining a delta value based on a number of transmissions within a predetermined time window; determining a total backoff value based on the base backoff value and the delta value; and outputting, for transmission, traffic based on the total backoff value.

Example 14 includes the method of example 13 or some other example herein, wherein determining the delta value comprises: determining the delta value with a cost function having parameters that include a first boundary number of transmissions associated with a delta value of 0% and a second boundary number of transmissions associated with a delta value of 100%.

Example 15 includes the method of example 14 or some other example herein, wherein the cost function is a Sigmoid-like cost function or a rectified-linear-like cost function.

Example 16 includes the method of example 14 or some other example herein, further comprising: determining the cost function or the parameters based on a priority level, application, or application type associated with the traffic.

Example 17 includes the method of example 13 or some other example herein, further comprising: determining the base backoff value is greater than a predetermined threshold; and determining the delta value based on said determining the base backoff value is greater than the predetermined threshold.

Example 18 includes the method of example 17 or some other example herein, further comprising: determining the predetermined threshold based on a priority level, application, or application type associated with the traffic.

Example 19 includes a method comprising: selecting, based on an indicator of a transmit (Tx) backoff level, a backoff value; and determining a mean value based on the backoff value; selecting a number within a range defined by a distribution having the mean value; determining a transmission cycle based on the number; and outputting traffic for transmission in the transmission cycle.

Example 20 includes the method of example 19 or some other example herein, wherein the distribution is a Poisson distribution.

Example 21 includes the method of example 19 or some other example herein, further comprising: determining the mean value is greater than a predetermined threshold; and selecting the distribution based on determining the mean value is greater than the predetermined threshold.

Another example may include an apparatus comprising means to perform one or more elements of a method described in or related to any of examples 1-21, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example may include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a first set of backoff values;
identifying a second set of backoff values;
selecting, based on an indicator of a transmit (Tx) backoff level, a first backoff value from the first set of backoff values and a second backoff value from the second set of backoff values, wherein the first backoff value is different from the second backoff value;
outputting, for transmission, first traffic based on the first backoff value; and
outputting, for transmission, second traffic based on the second backoff value.

2. The method of claim 1, wherein the first set of backoff values is associated with a first priority level and the second set of backoff values is associated with a second priority level.

3. The method of claim 2, further comprising:
determining a number of transmissions within a predetermined time window;
determining a delta value based on the number of transmissions;
determining a total backoff value based on the first backoff value and the delta value; and
outputting, for transmission, the first traffic based on the total backoff value.

4. The method of claim 3, wherein determining the delta value comprises:
determining the delta value with a cost function having parameters that include a first boundary number of transmissions associated with a delta value of 0% and a second boundary number of transmissions associated with a delta value of 100%.

5. The method of claim 4, wherein the cost function is a sigmoid-like cost function or a rectified-linear-like cost function.

6. The method of claim 4, wherein the total backoff value is a first total backoff value, the delta value is a first delta value, the cost function is a first cost function associated with the first priority level and the method further comprises:
determining a second delta value with a second cost function associated with the second priority level, wherein the second cost function has a third boundary number of transmissions associated with a delta value of 0% and a fourth boundary number of transmissions associated with a delta value of 100%, wherein the first boundary number is different from the third boundary number or the second boundary number is different from the fourth boundary number;
determining a second total backoff value based on the second backoff value and the second delta value; and
outputting, for transmission, the second traffic based on the second total backoff value.

7. The method of claim 1, wherein the first set of backoff values is associated with a first application and the second set of backoff values is associated with a second application.

8. The method of claim 1, further comprising:
identifying an indicator of a user experience (Ux) congestion level; and
providing, to a user, an indication of the Ux congestion level.

9. The method of claim 1, wherein the first backoff value and the second backoff value correspond to a first backoff percentage and a second backoff percentage, respectively.

10. The method of claim 1, wherein outputting the first traffic comprises:
determining, using a geometric distribution with the first backoff value, transmission of the first traffic is allowed; and
outputting, for transmission, the first traffic based on said determining that the transmission of the first traffic is allowed.

11. The method of claim 1, wherein outputting the first traffic comprises:
determining a mean value based on the first backoff value;
selecting a number within a range defined by a distribution having the mean value;
determining a transmission cycle based on the number; and
outputting the first traffic for transmission in the transmission cycle.

12. The method of claim 11, wherein the distribution is a Poisson distribution.

13. One or more non-transitory, computer-readable media having instructions that, when executed, cause processing circuitry to:
select, based on an indicator of a transmit (Tx) backoff level, a base backoff value from a set of backoff values;
determine a delta value based on a number of transmissions within a predetermined time window;
determine a total backoff value based on the base backoff value and the delta value; and
output, for transmission, traffic based on the total backoff value.

14. The one or more non-transitory, computer-readable media of claim 13, wherein to determine the delta value comprises:
determine the delta value with a cost function having parameters that include a first boundary number of transmissions associated with a delta value of 0% and a second boundary number of transmissions associated with a delta value of 100%.

15. The one or more non-transitory, computer-readable media of claim 14, wherein the cost function is a Sigmoid-like cost function or a rectified-linear-like cost function.

16. The one or more non-transitory, computer-readable media of claim 14, wherein the instructions, when executed, further cause the processing circuitry to:
determine the cost function or the parameters based on a priority level, application, or application type associated with the traffic.

17. The one or more non-transitory, computer-readable media of claim 13, wherein the instructions, when executed, further cause the processing circuitry to:
determine the base backoff value is greater than a predetermined threshold; and
determine the delta value based on determination that the base backoff value is greater than the predetermined threshold.

18. The one or more non-transitory, computer-readable media of claim 17, wherein the instructions, when executed, further cause the processing circuitry to:
determine the predetermined threshold based on a priority level, application, or application type associated with the traffic.

19. An apparatus comprising:
processing circuitry to:
selecting, based on an indicator of a transmit (Tx) backoff level, a backoff value;
determine a mean value based on the backoff value;
select a number within a range defined by a distribution having the mean value;
determine a transmission cycle based on the number; and
output traffic for transmission in the transmission cycle; and
interface circuitry coupled with the processing circuitry to enable communication.

20. The apparatus of claim 19, wherein the processing circuitry is further to:
determine the mean value is greater than a predetermined threshold; and
select the distribution based on determining the mean value is greater than the predetermined threshold.
